(19) United States
(12) Patent Application Publication
(10) Pub. No.: US 2014/0368450 A1
(43) Pub. Date: Dec. 18, 2014

(54) INFORMATION PROCESSING SYSTEM, INFORMATION PROCESSING APPARATUS, STORAGE MEDIUM HAVING STORED THEREIN INFORMATION PROCESSING PROGRAM, AND INFORMATION PROCESSING METHOD

(71) Applicant: NINTENDO CO., LTD., KYOTO (JP)

(72) Inventors: Takahiro TAKIGUCHI, Kyoto (JP); Eiichi SHIRAKAWA, Kyoto (JP)

(73) Assignee: NINTENDO CO., LTD., KYOTO (JP)

(21) Appl. No.: 14/103,064

(22) Filed: Dec. 11, 2013

(30) Foreign Application Priority Data
Jun. 12, 2013 (JP) 2013-124205

(51) Int. Cl. G06T 1/20; G06F 3/041

(52) U.S. Cl. CPC G06T 1/20; G06F 3/041
USPC 345/173; 345/502

(57) ABSTRACT

Provided are an information processing apparatus 1 having a taste as well as an information processing system, an information processing program and an information processing method using the information processing apparatus. The information processing apparatus 1 is one of those with different kinds of appearances from each other, thus having an appearance different from the others, and comprises: a ROM 29 storing appearance information related to the appearance in advance; LCDs 7, 9; and a data processing unit 20 for reading a software so as to process images to be displayed on the LCDs 7, 9. The data processing unit 20 reads the appearance information from the ROM 29, and allows the software to change the images displayed on the LCDs 7, 9. This allows the information processing apparatus 1 to have a different or better taste.

### BACKGROUND OF THE INVENTION

1. Field of the Invention

The present invention relates to an information processing apparatus with an image display device, an information processing system, a storage medium having stored therein an information processing program and an information processing method.

2. Description of the Related Art

Various screen operation methods of an image display device using e.g. a touch panel in an information processing apparatus are known. One screen operation method changes an image displayed on a touch panel or display screen at a position touched by a user to an appropriate different image. Another screen operation method provides a scroll bar on a touch panel so as to scroll an image in a direction in which the scroll bar is touched by a user, and detects a double touch for page turning (refer e.g. to Japanese Laid-open Patent Publication 2005-44036). However, the image display device as shown in the Japanese Laid-open Patent Publication 2005-44036 only makes it possible to change an image displayed on the touch panel by detecting operation on the touch panel.

### BRIEF SUMMARY OF THE INVENTION

An object of the present invention is to provide an information processing apparatus, an information processing system, a storage medium having stored therein an information processing program and an information processing method which can display, on a display screen, an image corresponding to a specific appearance of the information processing apparatus, thereby providing a new image display mode.

According to a first aspect of the present invention, this object is achieved by an information processing system comprising: a software; a first information processing apparatus which can execute the software and comprises an image display unit and a data processing unit; a second information processing apparatus which can execute the software and comprises a image display unit and a data processing unit, and which has an appearance different from an appearance of the first information processing apparatus, wherein the first information processing apparatus stores a first appearance information related to the appearance of the first information processing apparatus, wherein the second information processing apparatus stores a second appearance information related to the appearance of the second information processing apparatus, wherein the software allows the data processing unit of the first information processing apparatus to function as an image display control unit for generating, based on the first appearance information, a first corresponding image corresponding to the appearance of the first information processing apparatus and for displaying the first corresponding image on the image display unit of the first information processing apparatus, and wherein the software allows the data processing unit of the second information processing apparatus to function as an image display control unit for generating, based on the second appearance information, a second corresponding image corresponding to the appearance of the second information processing apparatus and for displaying the second corresponding image on the image display unit of the second information processing apparatus.

According to a second aspect of the present invention, this object is achieved by an information processing apparatus which comprises an image display unit and can execute a software which can be executed in common by a further information processing apparatus having an appearance different from an appearance of the information processing apparatus, the information processing apparatus further comprising: a storage unit for storing appearance information related to the appearance of the information processing apparatus; and a control unit for reading the appearance information from the storage unit and allowing the software to generate, based on the read appearance information, a corresponding image corresponding to the appearance of the information processing apparatus itself and to display the corresponding image on the image display unit.

According to the second aspect of the present invention, the appearance information can be information related to shape of the information processing apparatus.

The appearance information can also be information related to pattern of the information processing apparatus.

The appearance information can also be information related to color of the information processing apparatus.

The appearance information can also be information related to a combination of at least two of shape, pattern and color of the information processing apparatus.

In addition, the appearance information can also be a symbol or a number corresponding to a kind of the appearance of the information processing apparatus, the symbol or the number being stored in the storage unit as index information.

This information processing apparatus can be designed so that the control unit converts the index information stored in the storage unit to the appearance information, and allows the software to change an image on the image display unit corresponding to the appearance information after the conversion.

In the information processing apparatus, the corresponding image can be a fit image which fits the appearance of the information processing apparatus.

In the information processing apparatus, at least two kinds of the software can be present, and the corresponding image for one kind of the software can be different from the corresponding image for another kind of the software.

The information processing apparatus can be designed so that the control unit allows the software to output, from the information processing apparatus, audio corresponding to the appearance information.

The audio corresponding to the appearance information can be either an operation sound output from the information processing apparatus when the information processing apparatus is operated, or a background sound output from the information processing apparatus while the corresponding image is displayed on the image display unit.

The information processing apparatus can be designed to further comprise: a touch panel covering the whole or a part of the image display unit; and a housing having the image display unit, wherein the control unit allows the software to generate a virtual image which corresponds to the appearance information, and which is displayed on the image display unit in an area from a border between the housing and the image display unit so as to prevent formation of a gap between the housing and the virtual image.

The virtual image can be designed to show an operation button identical or similar to an operation button provided on the housing of the information processing apparatus.

According to a third aspect of the present invention, the above object is achieved by a computer-readable storage medium having stored therein an information processing program to be executed by a control unit of an information processing apparatus which comprises an image display unit and a storage unit storing appearance information related to an appearance of the information processing apparatus and can execute a software which can be executed in common by a further information processing apparatus having an appearance different from the appearance of the information processing apparatus, wherein the information processing program allows the control unit to function as: a read control unit for reading the appearance information from the storage unit; and an image control unit for allowing the software to generate a corresponding image, corresponding to the appearance of the information processing apparatus, based on the appearance information read from the storage unit by the read control unit.

According to a fourth aspect of the present invention, the above object is achieved by an information processing method to be executed by an information processing apparatus which comprises an image display unit and a storage unit storing appearance information related to an appearance of the information processing apparatus and can execute a software which can be executed in common by a further information processing apparatus having an appearance different from the appearance of the information processing apparatus, wherein the information processing method comprises: a read control step to read the appearance information from the storage unit; and an image control step to allow the software to generate a corresponding image, corresponding to the appearance of the information processing apparatus, based on the appearance information read from the storage unit by the read control step.

The first to fourth aspects of the present invention make it possible to display, on a display screen, an image corresponding to a specific appearance of an information processing apparatus so as to provide a taste to an information processing apparatus, an information processing system, a storage medium having stored therein an information processing program and an information processing method. More specifically, the present invention stores appearance information related to an appearance of an information processing apparatus in a memory or storage unit in advance, and changes an image, to be displayed on an image display unit, corresponding to the appearance information stored in the memory, making it possible to provide a taste to an information processing apparatus, an information processing system, a storage medium having stored therein an information processing program and an information processing method.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawing. It is to be noted that the drawing is shown for the purpose of illustrating the technical concepts of the present invention or embodiments thereof, wherein:

FIG. 1 is a schematic perspective view of an information processing apparatus according to an embodiment of the present invention;

FIG. 2 is a schematic block diagram of the information processing apparatus;

FIG. 3 is a table showing data formats to store appearance information of the information processing apparatus;

FIG. 4 is an example of a correspondence table between index information and the appearance information of the information processing apparatus;

FIG. 5 is a schematic plan view of a screen of the information processing apparatus as seen from above;

FIG. 6 is a schematic plan view of the screen of the information processing apparatus as seen from above when a virtual image is displayed on the screen;

FIG. 7 is a flow chart showing an example of steps in which a data processing unit displays a virtual image on the screen based on the appearance information of the information processing unit;

FIG. 8A is a schematic view showing a character displayed on the information processing apparatus, while FIG. 8B is a schematic view of the information processing apparatus according to a modified example, showing an example of the character with a change in display; and

FIG. 9 is a flow chart showing an example of steps to allow the information processing apparatus to change an image based on the appearance information.

### DETAILED DESCRIPTION OF THE INVENTION

Embodiments of the present invention, as best mode for carrying out the invention, will be described hereinafter with reference to the drawing. It is to be understood that the embodiments described herein are not intended as limiting, or encompassing the entire scope of, the present invention.

### Embodiment 1

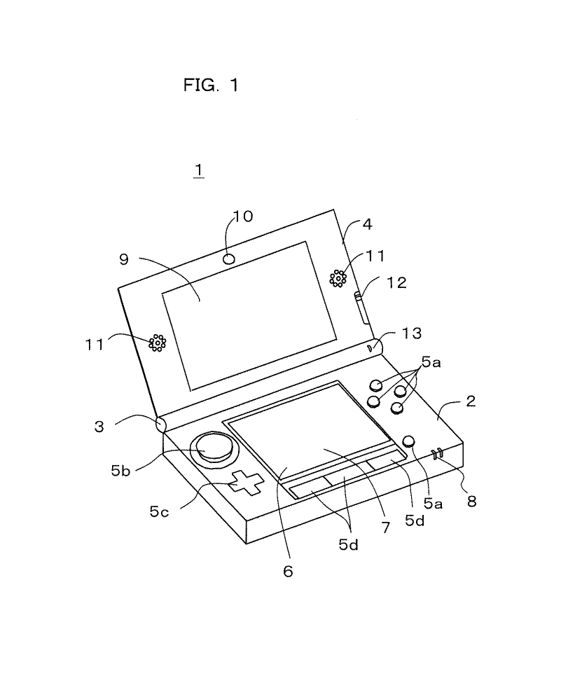

Referring to FIG. 1 to FIG. 7, an information processing apparatus 1, as well as an information processing system, a storage medium having stored therein an information processing program and an information processing method based on the information processing apparatus 1, according to Embodiment 1 of the present invention will be described. FIG. 1 is a schematic perspective view of the information processing apparatus 1. Referring to FIG. 1, the information processing apparatus 1 has a housing comprising a main body 2, a screen unit 4 and a hinge 3 connecting the screen unit 4 to the main body 2. The main body 2 comprises an operation unit 5 having operation buttons comprising round buttons 5a, a slide pad 5b, a cross button 5c and function buttons 5d. The main body 2 also comprises a light emitting diode (hereafter referred to as LED) 8, a lower liquid crystal device (hereafter referred to as LCD) (image display unit) 7 for displaying images such as those of various icons, characters and backgrounds, and a transparent touch panel 6 covering the whole or a part of the lower LCD 7.

The touch panel 6 is used to detect a touch position as an input position on a predetermined input surface (which is an entire image display surface of the lower LCD 7 in the present embodiment) so as to make various settings and perform various operations of e.g. application software and games. The LED 8 serves to indicate the operational state of the information processing apparatus 1. On the other hand, the screen unit 4 comprises an upper LCD (having a function of an image display unit) 9 for displaying images such as various icons, characters and background images, a camera 10, a speaker 11 and a control knob 12 to adjust the illumination of the upper LCD 9.

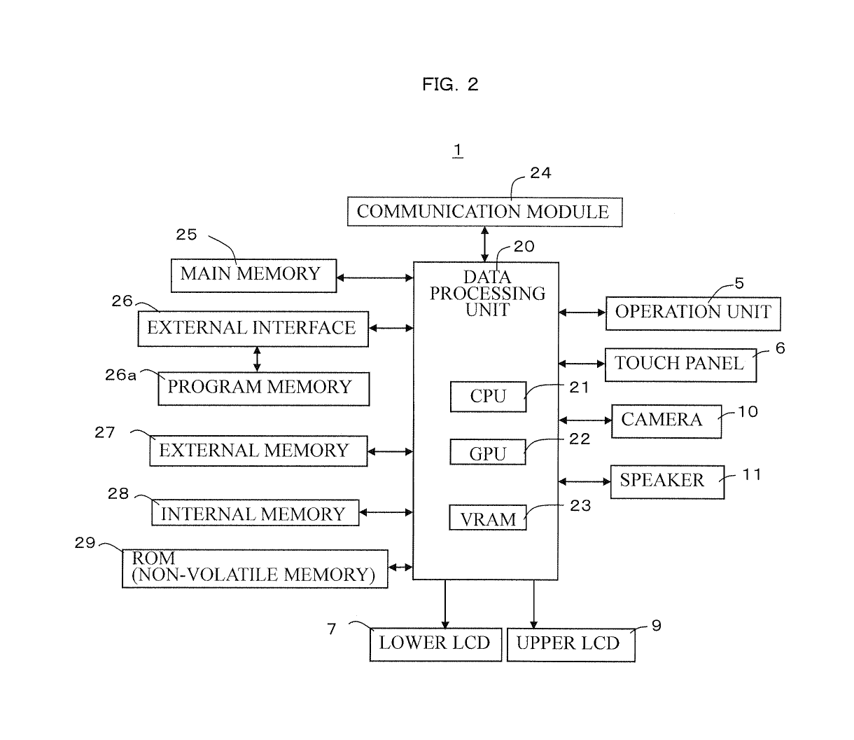

FIG. 2 is a schematic block diagram of the information processing apparatus 1. Referring to FIG. 2, the information processing apparatus 1 comprises a data processing unit 20 (having functions of a control unit and an image display control unit) comprising: a central processing unit (hereafter referred to as CPU) 21 (allowed by an information processing program to have functions of a read control unit and an image control unit) for executing a predetermined program; a graphics processing unit (hereafter referred to as GPU) 22 for processing images; and a video random access memory (hereafter referred to as VRAM) 23. The data processing 20 is connected to a communication module 24, a main memory 25, an external interface 26, a program memory 26a, an external memory 27, an internal memory 28 and a read only memory (hereafter referred to as ROM) 29, and the like described below.

The communication module 24 sends and receives data and programs to and from external devices such as servers. The main memory 25 temporarily stores programs, data and the like processed by the CPU 21. The external interface 26 sends data to be sent and received between the program memory 26a storing programs or a memory storing data or the like and the data processing unit 20. The external memory 27 is a non-volatile rewritable memory which is attachable and detachable to and from the information processing apparatus 1 from outside, while the internal memory 28 is a non-volatile rewritable memory built in the information processing apparatus 1. The ROM 29 (having a function of a storage unit) is a non-volatile non-rewritable memory built in the information processing apparatus 1. The external memory 27, the internal memory 28 and the ROM 29 respectively store data. The operation unit 5 comprises the round buttons 5a, the slide pad 5b, the cross button 5c and the function buttons 5d described above.

According to the present embodiment, at least two kinds of housings of the information processing apparatus 1 with different appearances are present. The housing of the information processing apparatus 1 shown in FIG. 1 is one of the at least two kinds of housings. Here, the appearance of the housing of the information processing apparatus 1 includes color, pattern and the like. For example, it can be a housing with a white color, a housing with a red color, a housing with a blue color, a housing with a white color and a pattern, a housing with a red color and a pattern, a housing with a blue color and a pattern, or the like. The appearance of the housing of the information processing apparatus 1 also includes color, shape, placement and the like of the operation buttons such as the round buttons 5a provided on the housing of the information processing apparatus 1. For example, the shape of the operation buttons can be not only the round shape as in the round buttons 5a described above, but also a rectangular shape and a triangular shape. Further, the operation buttons can have a special shape formed thereon. In addition, the operation buttons can vary in number, color, placement position, placement distance (between them), and the like. The term “appearance” used herein is not limited to those described above, but means any feature of the information processing apparatus 1 which a user can feel and perceive by looking at it from outside.

While multiple kinds of housings of the information processing apparatus 1 with different appearances are present as described above, a program (software as an information processing program) which can be executed by the information processing apparatus 1 is basically common to all the information processing apparatus with different appearances regardless of the different appearances. In other words, while a program can be executed in common by all the information processing apparatus regardless of the differences in appearance of the information processing apparatus, each of the information processing apparatus with multiple different appearances has an individuality.

The present embodiment describes the structure of the information processing apparatus 1 having the data processing unit 20 and other components which make it possible to distinguish and determine at least one kind of other information processing apparatus having an appearance different from an appearance of the information processing apparatus 1. Appearance information 29a (not shown) related to an appearance (as described above) of the information processing apparatus 1 itself is stored in a storage medium such as the ROM 29 in advance, e.g. at factory before shipment, so as to enable the information processing apparatus 1 itself to handle the appearance information 29a appropriately. The appearance information 29a is information representing an appearance as described above, and includes information related to e.g. shape, pattern, color, or a combination of these, of (the housing of) the information processing apparatus 1.

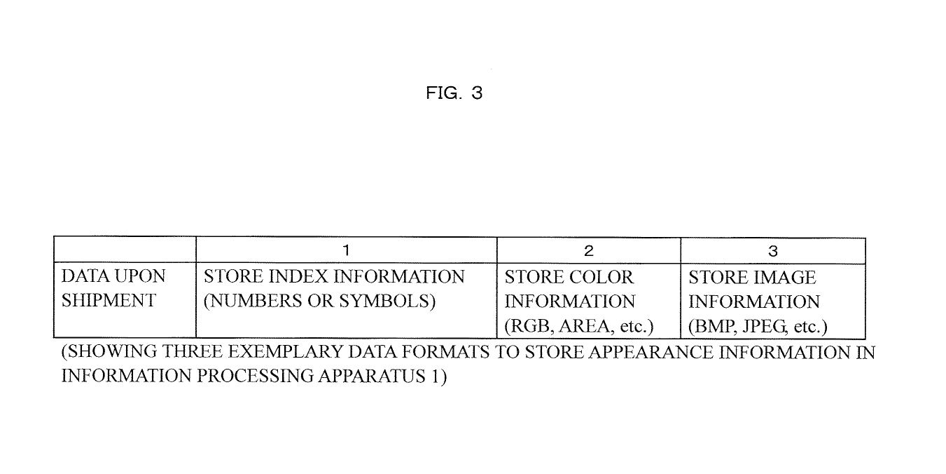

FIG. 3 is a table showing data formats to store the appearance information 29a of the information processing apparatus 1. FIG. 3 shows three kinds of data formats as examples of data formats for the appearance information 29a of the information processing apparatus 1. The appearance information 29a is stored in the information processing apparatus 1 in one of the data formats. The “index information” described in column 1 of the table as a data format of the appearance information 29a means a number or a symbol which represents each factor forming the appearance of the information processing apparatus 1 such as color and shape of the housing, the operation buttons of the operation unit 5 and so on. For example, index “0” and index “1” can be used for white color and red color of the housing of the information processing apparatus 1, respectively, while index “A”, index “B” and index “C” can be used for round shape, rectangular shape and triangular shape of the buttons 5a (assuming to change the round shape of the round buttons 5a of the operation buttons shown in FIG. 1), respectively.

It is also possible to use indices each representing a combination of factors forming the appearance of the information processing apparatus 1 such as color and shape of the housing and operation buttons of the operation unit 5, and so on. For example, index “1” can be used for a combination of white color of the housing and rectangular shape of the buttons 5a, while index “2” can be used for a combination of red color of the housing and triangular shape of the buttons 5a. Note that the index information is simple information using a number or a symbol (which basically has a smaller amount of data than e.g. RGB, BMP and JPG described below), so that a correspondence table (reference table) described later is required in order to determine the appearance represented by each index.

On the other hand, the “color information” described in column 2 of the table means information related to the color of the housing and operation buttons of the information processing apparatus 1 as represented by values e.g. based on color expression of RGB (Red/Green/Blue) and area. Further, the “image information” in column 3 of the table means information of an image (which can include color and pattern) showing the whole or a part of the appearance of the information processing apparatus 1 in an image file format such as BMP (Bitmap) format, JPG (Joint Photographic Experts Group) format and so on to enable reproduction of the appearance of the information processing apparatus 1.

Although the three kinds of data formats have been described above as examples of the appearance information 29a to be stored in the information processing apparatus 1, the appearance of the information processing apparatus 1 can be reproduced by only one kind of data format stored in the information processing apparatus 1, so that it is sufficient to use only one of the three kinds of data formats to store the appearance information 29a. Further, not only the shape and color of the buttons 5a (round buttons 5a) described above, but also the shape and color of the slide pad 5b, the cross button 5c and the function buttons 5d can be stored in the ROM 29 as index information, color information and image information. The format to store the appearance information 29a is not limited to the data formats described above, and can be any formats of information to allow reproduction of appearance. Further, the storage medium is not necessarily the ROM 29 (regardless of the presence of non-volatility or rewritability), and can be any medium which can store a required amount of information.

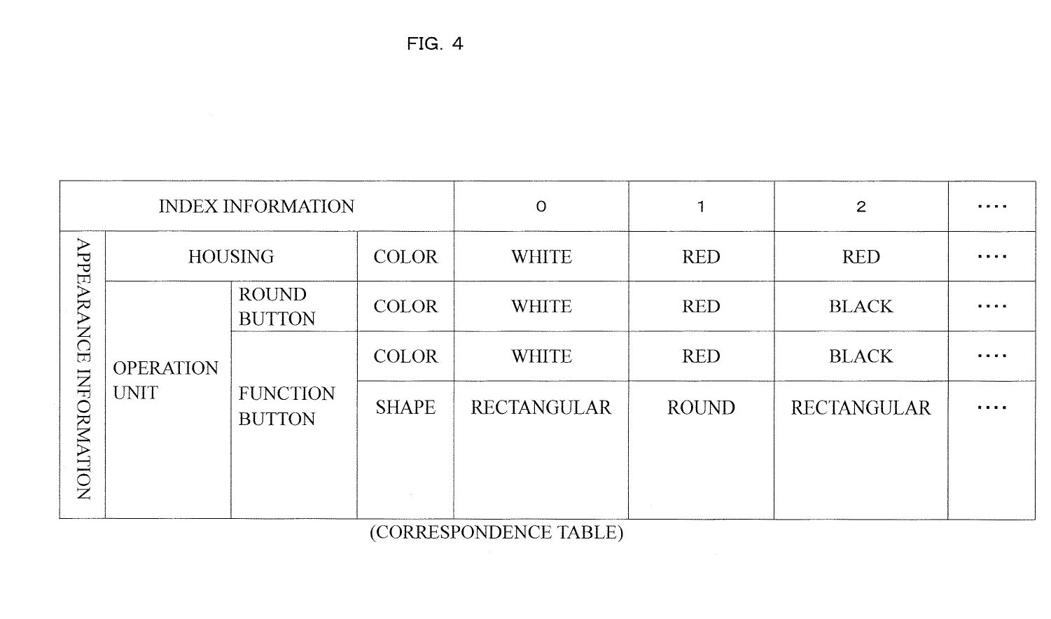

The following describes a method of determining the appearance, such as color, of the information processing apparatus 1 by reading the appearance information 29a from the ROM 29 after the appearance information 29a is stored in the ROM 29. If index information is stored in the ROM 29, a correspondence table is required which describes index information and the appearance information 29a related to the appearance of the information processing apparatus 1 such as color and shape corresponding to the index information. FIG. 4 is an example of a correspondence table between index information and the appearance information 29a of the information processing apparatus 1, in which each index represents a combination of factors forming the appearance of the information processing apparatus 1 as described above. In the correspondence table of FIG. 4, certain combinations of color of the housing, color of the round buttons 5a, and color and shape of the function buttons 5d of the information processing apparatus 1 are stored corresponding to the index information.

It can be determined from the correspondence table that, for example, if the number of the index information read from the ROM 29 is “0”, the color of the housing of the information processing apparatus 1 is white, and the color of the round buttons 5a is white, while the color and shape of the function buttons 5d is white and rectangular, respectively. The appearance of the information processing apparatus 1 cannot be determined only by reading the index information from the ROM 29 if the correspondence table is absent. Thus, in order to allow the information processing apparatus 1 to determine the appearance of itself, the correspondence table is stored in advance in the ROM 29 or the like of the information processing apparatus 1, whereby when the index information is read from the ROM 29 or the like, the index information of a number or a symbol is converted by the data processing unit 20 (having a function of a control unit) to the appearance information of the information processing apparatus 1 such as the color and shape of each of the housing and the operation buttons so as to determine the appearance information. Note that instead of being stored in the ROM 29, the correspondence table can be stored in advance in a program e.g. of an application software or a game connected to the external interface 26, or can be downloaded from an external device or internet via the communication module 24.

If color information (RGB values) is stored in the ROM 29 as the appearance information 29a, it is not necessary to use a corresponding table such as the one described above. This is because if values of e.g. RGB color expression are stored in the ROM 29a, the color of the housing, the color of the operation unit 5 and the like of the information processing apparatus 1 can be directly reproduced from e.g. the stored RGB values. The color information to be stored can include not only the color of the appearance, but also area information, including placement, e.g. of the operations buttons of the operation unit 5. Here, the area information means e.g. area of the operation buttons and other areas in the whole of the appearance showing the placement of the operation buttons of the operation unit 5 of the information processing apparatus 1, in which RGB values (color map) corresponding to the respective areas can be stored as color information. The color information can be used to reproduce the appearance of the information processing apparatus 1 itself.

If image information is stored in the ROM 29 as the appearance information 29a, the image information can be directly used as an image showing the whole or a part of the appearance of the information processing apparatus 1. Methods of storing image information include e.g. a method of storing an image of the whole appearance of the information processing apparatus 1, and a method of storing only an image of an area of the information processing apparatus 1 where the operation unit 5 is placed. Assume a case where the whole or a part of the appearance of the information processing apparatus 1 can be reproduced by combining specific images, e.g. where the whole or a part of the information processing apparatus 1 can be expressed by combining a unique image, such as having a unique peripheral shape of the information processing apparatus 1, with a non-unique image such as of an area of the information processing apparatus 1 surrounded by its periphery, which has a monochromatic color and no unique feature in shape. In such a case, an example of the method is to store the unique image, the non-unique image, and an image placement diagram to combine the unique and non-unique images. Note, however, that while the required storage capacity of the ROM 29 to store the index information is small, a larger storage capacity is required to store the color information or the image information than to store the index information.

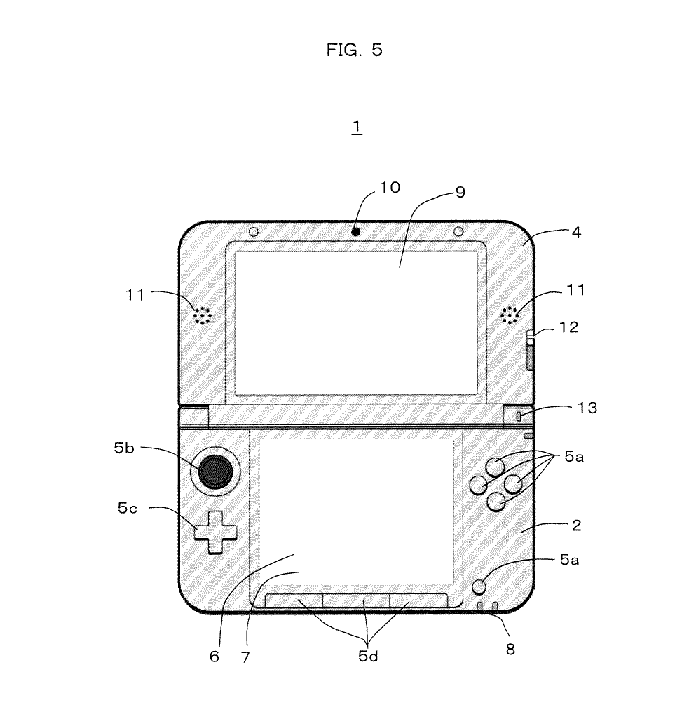

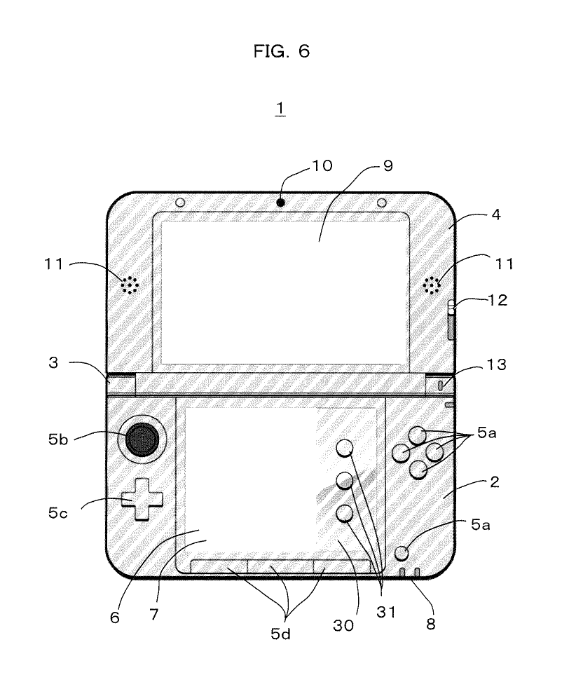

Hereinafter, referring to FIG. 5 and FIG. 6, image display using the appearance information 29a stored in the ROM 29 will be described. FIG. 5 is a schematic plan view of the screen (lower and upper LCDs 7, 9 and other elements) of the information processing apparatus 1 as seen from above. Referring to FIG. 5, images of e.g. various icons, characters and backgrounds are displayed on the upper LCD 9 when a program e.g. of an application software or a game is executed. On the other hand, the lower LCD 7 is covered with the touch panel 6. Thus, while looking at the images displayed on the lower LCD 7, a user can touch the touch panel 6 with e.g. a touch pen at a position of each such displayed image so as to make various settings and perform various operations of e.g. the application software and the game to be executed.

FIG. 6 is a schematic plan view of the screen of the information processing apparatus 1 as seen from above, when a virtual image is displayed on the screen. More specifically, referring to FIG. 6, the information processing apparatus 1 displays a virtual image 30 on the lower LCD 7. The CPU 21 reads a program e.g. of an application software or a game stored in the program memory 26a connected to the external interface 26 and also reads appearance information 29a stored in the ROM 29 shown in FIG. 2 to generate and display the virtual image 30, which is an image showing various icons and backgrounds, the operation unit 5, and so on. If the program is downloaded via the communication module 24 and is stored in the external memory 27 or the internal memory 28, the CPU 21 reads the program from the external memory 27 or the internal memory 28. Note that such a program e.g. of an application software program or a game is not necessarily stored in an external storage medium such as the program memory 26a, and can be downloaded from a server via the internet, or can be stored in an internal storage medium of the information processing apparatus 1 already at the initial stage.

The virtual image 30 is generated by the data processing unit 20 based on the appearance information 29a stored in the ROM 29 and the above program read by the CPU 21. More specifically, if index information is stored in the ROM 29 as the appearance information 29a, the CPU 21 (data processing unit 20) determines the color of the housing of the information processing apparatus 1 itself as well as the color and shape of the operation unit 5, and so on by referring the read index information to the above correspondence table. On the other hand, if color information is stored in the ROM 29 as the appearance information 29a, the CPU 21 reproduces the color, pattern and the like of the housing, the operation unit 5 and so on of the information processing apparatus 1 from the color information, which gives RGB values corresponding to the housing, the buttons of the operation unit 5 and so on of the information processing apparatus 1.

Further, if image information is stored in the ROM 29 as the appearance information 29a, the CPU 21 reproduces the color, shape and the like of the housing, the operation unit and so on of the information processing apparatus 1 from the stored image information representing the whole or a part of the appearance of the image processing apparatus 1. The virtual image 30 is generated such that an image showing a background with a pattern (including color) identical or similar to the housing of the information processing apparatus 1 is generated based on the above appearance information 29a, and that a further image showing round buttons identical or similar to the round buttons 5a provided on the housing of the information processing apparatus 1 is similarly generated based on the appearance information 29a and displayed on the image showing the background. In other words, the virtual image 30 shows an operation button(s) identical or similar to that (those) provided on the housing of the information processing apparatus. Thus, the CPU 21 (data processing unit 20) generates virtual images 30 of, for example, the operation unit, the operation buttons, and so on (i.e. virtual operation unit, virtual operation buttons and so on).

The example of the displayed virtual image 30 shown in the above description is identical or similar to the appearance information 29a of the information processing apparatus 1, which displays the virtual image 30. In contrast, however, the CPU 21 (data processing unit 20) can be designed to generate and display an image showing a background with a pattern (including color) completely different from the appearance information 29a of the information processing apparatus 1, and generate a further image showing buttons which are different in shape from the round buttons 5a provided on the housing of the information processing apparatus 1. The CPU 21 can also be designed to generate and display a background image related to the appearance information 29a and a new image of buttons with a rectangular shape (index “B”) or a triangular shape (index “C”), which is different in shape from the image of the buttons (round buttons 5a) with a round shape (index “A”) provided on the housing of the information processing apparatus 1. The CPU 21 can also be designed to generate an image identical or similar to the appearance information 29a and an image completely different from the appearance information 29a so as to display a combination of the two images.

As described above, the virtual image 30 is generated from and based on the appearance information 29a so as to correspond to the appearance of the information processing apparatus 1 itself. FIG. 6 shows a corresponding image 31, as an example of the virtual image 30, which is thus based on the appearance information 29a and corresponds to the appearance of the information processing apparatus 1 itself. When the corresponding image 31 is displayed on the lower LCD 7 or the upper LCD 9 of the information processing apparatus 1, the corresponding image 31 may, in some cases, be good looking to fit the appearance of the information processing apparatus 1, while in other cases the corresponding image 31 may not be good looking.

Thus, in order for the information processing apparatus 1 to have a different or better taste due to the virtual image 30 displayed on the lower LCD 7 or the upper LCD 9, the information processing apparatus 1 can be designed to determine in advance whether an image being generated as a candidate of the virtual image 30 and being identical or similar to the appearance information 29a of the information processing apparatus 1 is good looking, thereby determining the good looking candidate as a fit image 32 (not shown), and to display the fit image 32, thus determined, as the virtual image 30. Examples of the good looking fit images 32, as assumed, are not only a virtual image 30 identical or similar to the information processing apparatus 1 and giving a feeling of integration with the information processing apparatus 1, but also a virtual image 30 in a color complementary to the color of the appearance of the information processing apparatus 1, and so on. Furthermore, if the housing of the information processing apparatus 1 has a horizontal stripe pattern, an example of the fit image 32 can be an inversely related virtual image 30 with e.g. a vertical stripe pattern.

The lower LCD 7 is covered with the touch panel 6 so that the area of the virtual image 30 showing e.g. each round button, i.e. each round button area, functions like an actual operation button when a user touches the round button area. FIG. 6 shows an example of the virtual image 30 giving a feeling of integration with the information processing apparatus 1. Thus, as shown in FIG. 6, the virtual image 30 is displayed on the lower LCD in an area from a border between the lower LCD 7 and the housing of the information processing apparatus 1 so as to prevent formation of a gap between the virtual image 30 and the housing of the information processing apparatus 1. This design of virtual image 30 gives a feeling of integration between the round buttons 5a provided on the housing of the information processing apparatus 1 and the round buttons (virtual operation buttons) in the virtual image 30. In other words, the displayed virtual image 30 corresponding to the appearance of the information processing apparatus 1 allows the information processing apparatus 1 to have a taste. Note that the provision of the virtual operation buttons described above is also effective if the provision of the round buttons 5a, the slide pad 5b, the cross button 5c and the function buttons 5d alone is insufficient to execute a program in some cases.

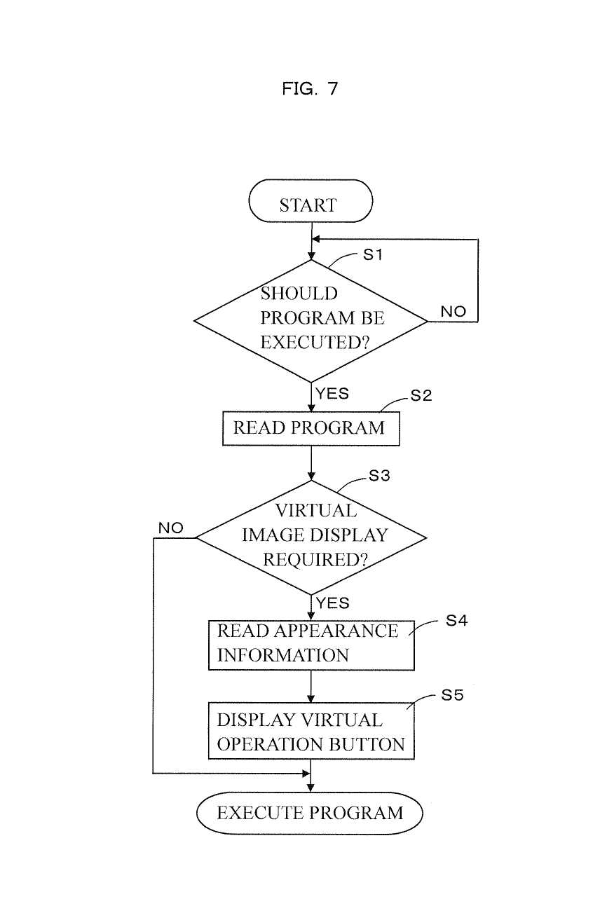

FIG. 7 is a flow chart showing an example of steps in which the CPU 21 (data processing unit 20) displays a virtual image 30 on the lower LCD 7 based on the appearance information 29a of the information processing unit 1. Referring to FIG. 7, when a round button 5a to execute e.g. a program of a game is pressed by a user to allow the CPU 21 to determine that such a program should be executed (S1), the CPU 21 reads the program from the program memory 26a connected to the external interface 26 (S2). The CPU 21 then determines from the program whether there is a display command to require display of a virtual image 30 based on the appearance information 29a (S3). If there is a display command to display the virtual image 30 based on the appearance information 29a, the CPU 21 reads the appearance information 29a from the ROM 29 (S4).

Then, the CPU 21 generates the virtual image 30 from the read program and the appearance information 29a, and displays the generated virtual image 30 on the lower LCD 7 (S5), and executes the program. If there is no display command to display a virtual image 30 based on the appearance information 29a (NO in S3), the CPU 21 directly executes the program. Thus, it is understood that the CPU 21 performs a read control step to read the appearance information 29a from the ROM 29, and an image control step to allow the program (software) to generate a corresponding image corresponding to the appearance of the information processing apparatus 1, and display the generated corresponding image on the lower LCD 7.

### Modified Example 1 of Embodiment 1

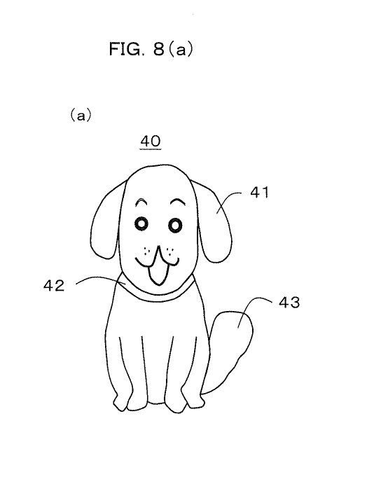

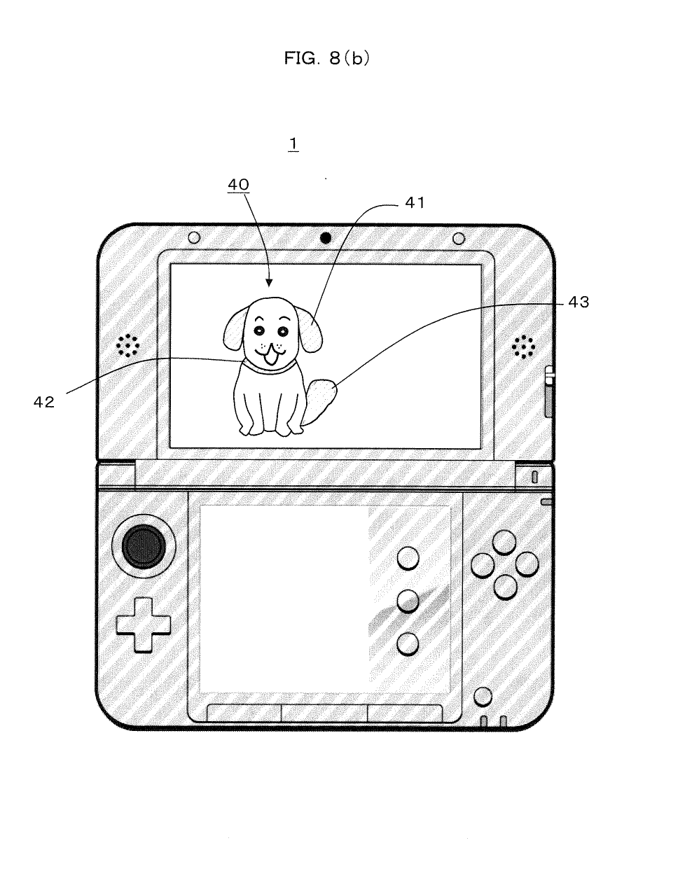

Referring to FIGS. 8A and 8B, an information processing apparatus 1 according to Modified Example 1 of the present invention, which is a modification of Embodiment 1, will be described. FIG. 8A is a schematic view showing a character 40 displayed on the information processing apparatus 1, more specifically a character 40 which is a main character in a given game to be displayed on the upper LCD 9 when a program of the game is executed. The character 40 is characterized by long flapping ears 41, a collar 42 and a bushy tail 43. In the present Modified Example 1, in order to give a feeling of integration between the character 40 and the information processing apparatus 1, the design of the ears 41, the collar 42 and the tail 43 of the character 40 is changed to be similar or correspond to the appearance of the information processing apparatus 1, as shown, for example, in FIG. 8B below.

FIG. 8B is a schematic view of the information processing apparatus 1 according to the present Modified Example 1, showing an example of the character 40 with a change in display. If the appearance of the information processing apparatus 1 to execute the program of the game has a stripe pattern, for example, each of the ears 41, the collar 42 and the tail 43 of the character 40 is provided with the stripe pattern, as shown in FIG. 8B, to give a feeling of integration between the character 40 and the information processing apparatus 1. Multiple kinds (At least two kinds) of software to be executed by the information processing apparatus 1 are present, and similarly multiple kinds of characters are present, so that images (corresponding images) to be displayed corresponding to the appearance information 29a are different for the respective kinds of software.

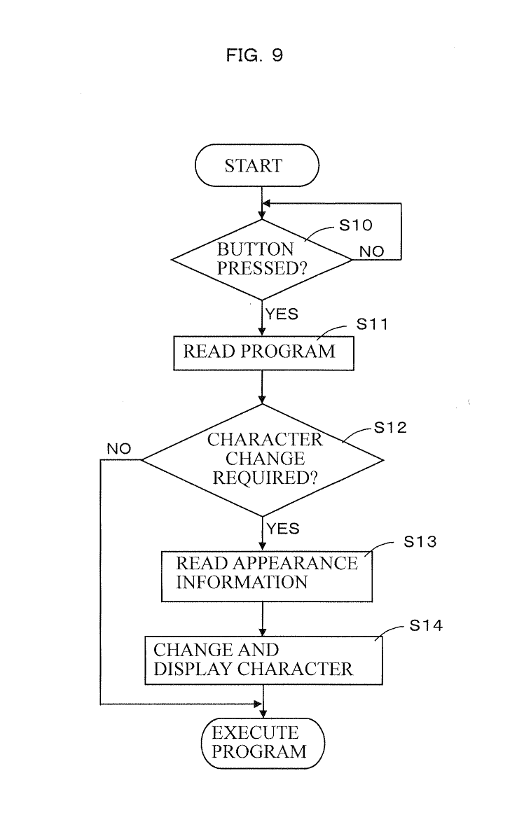

FIG. 9 is a flow chart showing an example of steps to allow the information processing apparatus 1 to change an image based on the appearance information 29a, more specifically, to allow the CPU 21 (data processing unit 20) to display a character 40 of a game on the upper LCD 9. Referring to FIG. 9, when a round button 5a to execute e.g. a program of a game is pressed by a user (S10), the CPU 21 reads the program from the program memory 26a connected to the external interface 26 (S11). The CPU 21 then determines from the program whether there is a display change command to require a display change of a character 40 based on the appearance information 29a (S12).

If there is a display change command to require a display change of the character 40 based on the appearance information 29a, the CPU 21 reads the appearance information 29a from the ROM 29 (S13). Then, the CPU 21 changes the display of the character 40 based on the read program and the appearance information 29a, and displays the changed character 40 on the lower LCD 7 (S14), and executes the program. If there is no display change command to require a display change of the character 40 based on the appearance information 29a (NO in S12), the CPU 21 directly executes the program. Note that whether the display change of the character 40 is required can be determined by designing the information processing apparatus 1 (CPU 21) to display a question (YES/NO) on the requirement on the lower LCD 7, and allow the user to enter YES/NO using a round button 5a. The information processing apparatus 1 can also be designed to automatically change the display of the character 40 without determining the requirement for the display change of the character 40.

As described above, in Modified Example 1, it is assumed that the information processing apparatus 1 is one of those with multiple different kinds of appearances. Features of the multiple kinds of appearances of the information processing apparatus 1 are stored as appearance information 29a in the ROM 29. Before executing a program of a game, the appearance information 29a is read from the ROM 29 so as to display an image corresponding to the read appearance information 29a on the lower LCD 7 or the upper LCD 9. This image display allows the image display of the game to be related to the information processing apparatus 1, and makes it possible to give a feeling of integration between the game and the information processing apparatus 1. Further, the image display of the game is allowed to change based on the appearance of the information processing apparatus 1, so that the image display of the game can give different feelings or impressions to a user for the different kinds of appearances of the information processing apparatus 1. This makes it possible for an information processing apparatus 1 with a certain appearance to have a different or better taste compared to an information processing apparatus 1 with another appearance.

It is to be note that in the information processing apparatus 1 of Embodiment 1 and Modified Example 1 described above, the design of the virtual image 30 and the character 40 of a game are changed for image display corresponding to the appearance information 29a of the information processing apparatus 1. However, it is not limited to games. More specifically, the information processing apparatus 1 can be designed so that images such as those of various icons, backgrounds and characters of various application software other than games are changed corresponding to the appearance information 29a of the information processing apparatus 1. Furthermore, the touch panel 6 is not necessarily required. The information processing apparatus 1 is only required to have some image display device such as an LCD to display a virtual image 30.

### Modified Example 2 of Embodiment 1

In Embodiment 1 and Modified Example 1 described above, the data processing unit 20 of the information processing apparatus 1 uses the appearance information 29a of the information processing apparatus 1 and allows e.g. an application software to display, based on the appearance information 29a, an icon, a character 40, a background (with a given color) and the like of the virtual image 30 on the lower LCD 7 or the upper LCD 9 of the information processing apparatus 1. In contrast, in the present Modified Example 2, which is another modification of Embodiment 1, the information processing apparatus 1 is designed to output audio (sound) corresponding to the appearance information 29a from the speaker 11 or an earphone jack (not shown) of the information processing apparatus 1.

For example, the storage unit of the information processing apparatus 1 stores data of audio to be output, such as data of operation sound, background sound and the like described later, as well as a table data showing data of audio respectively corresponding to various appearance information 29a. While executing an application software or a game program, the data processing unit 29 refers to the table data to read data of audio corresponding to an appearance information 29a of the information processing apparatus 1 so as to output an operation sound of an operation button, a background sound (e.g. background music) and the like of the information processing apparatus 1. For example, the data processing unit 20 changes the tone of the operation sound of an operation button corresponding to the appearance information 29a. Further, if for example the appearance of the information processing apparatus 1 has e.g. an animal drawn thereon such as a dog, a cat or the like, the data processing unit 20 selects a sound of the animal for the operation sound of the operation button. Further, the data processing unit 20 selects, for example, a first music as a background music if the color of the appearance of the information processing apparatus 1 is red, while selecting a second music (different from the first music) as the background music if the color of the appearance is blue.

Similarly, in the case where the appearance of the information processing apparatus 1 has e.g. an animal drawn thereon such as a dog, a cat or the like, the data processing unit 20 of the information processing apparatus 1 can be designed to display an image of the animal as a corresponding image 31 on the lower LCD 7 or the upper LCD 9, and to select a sound of the animal for the operation sound of the operation button. The data processing unit 20 can also be designed to output the first music, the second music or the like while displaying the corresponding image 31. According to the present Modified Example 2, the data processing unit 20 can allow e.g. an application software or a game program to read the data of audio so as to output audio (sound) corresponding to the appearance information 29a from the information processing apparatus 1. The audio (sound) corresponding to the appearance information 29 includes not only operation sounds (i.e. those output from the information processing apparatus 1 when the information processing apparatus 1 is operated) and background sounds, but also any audio output from the information processing apparatus 1, including audio such as a background sound which is output from the information processing apparatus 1 while the corresponding image 31 is displayed on the lower LCD 7 or the upper LCD 9.

It is to be noted that the present invention is not limited to the above-described embodiments and modified examples, and various modifications are possible within the spirit and scope of the present invention. The present invention has been described above using presently preferred embodiments, but such description should not be interpreted as limiting the present invention. Various modifications will become obvious, evident or apparent to those ordinarily skilled in the art, who have read the description. Accordingly, the appended claims should be interpreted to cover all modifications and alterations which fall within the spirit and scope of the present invention.

This application is based on Japanese patent application 2013-124205 filed Jun. 12, 2013, the content of which is hereby incorporated by reference.

1. An information processing system comprising:
a software;
a first information processing apparatus which can execute the software and comprises an image display unit and a data processing unit;
a second information processing apparatus which can execute the software and comprises a image display unit and a data processing unit, and which has an appearance different from an appearance of the first information processing apparatus,
wherein the first information processing apparatus stores a first appearance information related to the appearance of the first information processing apparatus,
wherein the second information processing apparatus stores a second appearance information related to the appearance of the second information processing apparatus,
wherein the software allows the data processing unit of the first information processing apparatus to function as an image display control unit for generating, based on the first appearance information, a first corresponding image corresponding to the appearance of the first information processing apparatus and for displaying the first corresponding image on the image display unit of the first information processing apparatus, and
wherein the software allows the data processing unit of the second information processing apparatus to function as an image display control unit for generating, based on the second appearance information, a second corresponding image corresponding to the appearance of the second information processing apparatus and for displaying the second corresponding image on the image display unit of the second information processing apparatus.

2. An information processing apparatus which comprises an image display unit and can execute a software which can be executed in common by a further information processing apparatus having an appearance different from an appearance of the information processing apparatus, the information processing apparatus further comprising:
a storage unit for storing appearance information related to the appearance of the information processing apparatus; and
a control unit for reading the appearance information from the storage unit and allowing the software to generate, based on the read appearance information, a corresponding image corresponding to the appearance of the information processing apparatus itself and to display the corresponding image on the image display unit.

3. The information processing apparatus according to claim 2, wherein the appearance information is information related to shape of the information processing apparatus.

4. The information processing apparatus according to claim 2, wherein the appearance information is information related to pattern of the information processing apparatus.

5. The information processing apparatus according to claim 2, wherein the appearance information is information related to color of the information processing apparatus.

6. The information processing apparatus according to claim 2, wherein the appearance information is information related to a combination of at least two of shape, pattern and color of the information processing apparatus.

7. The information processing apparatus according to claim 2, wherein the appearance information is a symbol or a number corresponding to a kind of the appearance of the information processing apparatus, the symbol or the number being stored in the storage unit as index information.

8. The information processing apparatus according to claim 7, wherein the control unit converts the index information stored in the storage unit to the appearance information, and allows the software to change an image on the image display unit corresponding to the appearance information after the conversion.

9. The information processing apparatus according to claim 2, wherein the corresponding image is a fit image which fits the appearance of the information processing apparatus.

10. The information processing apparatus according to claim 2, wherein at least two kinds of the software are present, and the corresponding image for one kind of the software is different from the corresponding image for another kind of the software.

11. The information processing apparatus according to claim 2, wherein the control unit allows the software to output, from the information processing apparatus, audio corresponding to the appearance information.

12. The information processing apparatus according to claim 11, wherein the audio corresponding to the appearance information is either an operation sound output from the information processing apparatus when the information processing apparatus is operated, or a background sound output from the information processing apparatus while the corresponding image is displayed on the image display unit.

13. The information processing apparatus according to claim 2, further comprising:
a touch panel covering the whole or a part of the image display unit; and
a housing having the image display unit,
wherein the control unit allows the software to generate a virtual image which corresponds to the appearance information, and which is displayed on the image display unit in an area from a border between the housing and the image display unit so as to prevent formation of a gap between the housing and the virtual image.

14. The information processing apparatus according to claim 13, wherein the virtual image shows an operation button identical or similar to an operation button provided on the housing of the information processing apparatus.

15. A computer-readable storage medium having stored therein an information processing program to be executed by a control unit of an information processing apparatus which comprises an image display unit and a storage unit storing appearance information related to an appearance of the information processing apparatus and can execute a software which can be executed in common by a further information processing apparatus having an appearance different from the appearance of the information processing apparatus,
wherein the information processing program allows the control unit to function as:
a read control unit for reading the appearance information from the storage unit; and
an image control unit for allowing the software to generate a corresponding image, corresponding to the appearance of the information processing apparatus, based on the appearance information read from the storage unit by the read control unit.

16. An information processing method to be executed by an information processing apparatus which comprises an image display unit and a storage unit storing appearance information related to an appearance of the information processing apparatus and can execute a software which can be executed in common by a further information processing apparatus having an appearance different from the appearance of the information processing apparatus,
wherein the information processing method comprises:
a read control step to read the appearance information from the storage unit; and
an image control step to allow the software to generate a corresponding image, corresponding to the appearance of the information processing apparatus, based on the appearance information read from the storage unit by the read control step.
